(19) United States
(12) Patent Application Publication
(10) Pub. No.: US 2009/0232943 A1
(43) Pub. Date: Sep. 17, 2009

(54) Stabilized vitamin solutions; use thereof; process for their production; and formulations comprising the same

(76) Inventor: Aly Gamay, McLean, VA (US)

Correspondence Address: ALY GAMAY, 1102 MILL RIDGE, MCLEAN, VA, 22102, US

(21) Appl. No.: 12/073,913

(22) Filed: Mar. 12, 2008

(51) Int. Cl. A23L 1/302

(52) U.S. Cl. 426/72

(57) ABSTRACT

This invention relates to improved composition and method for producing individual dosages of nutritional supplements containing a large dose of stable ascorbic acid, vitamins and herbal extracts having extended shelf life without substantial degradation for mammals. The process involves heating a mixture of ascorbic acid and a humectant to elevated temperature with agitation to stabilize ascorbic acid at selected water activity.

### FIELD OF INVENTION

The present invention relates to composition of stabilized ascorbic acid and nutritional supplement solutions, use thereof, process for their production, and formulations comprising the same. This invention further relates to a process for manufacturing concentrated stabilized ascorbic acid and vitamin solutions in single dose unit with long shelf-life.

### BACKGROUND

Vitamin C (ascorbic acid) is a vital nutrient for humans and has many important functions in-the body. Vitamin C is essential for collagen synthesis and helps maintain the integrity of substances of mesenchymal origin, such as connective tissue, osteoid tissue, and dentin. An essential function of ascorbic acid is to act as a cofactor for the hydroxylation of proline and lysine residues in collagen, a major protein component of the body that is important in maintaining healthy skin elasticity and texture. Ascorbic acid is further essential for wound healing and facilitates recovery from burns. Being a strong reducing agent, ascorbic acid is reversibly oxidized and reduced in the body, functioning as a redox system in the cell and being useful in the treatment of cancer. It is involved in the metabolism of phenylalanine and tyrosine. Vitamin C facilitates the absorption of iron and protects folic acid reductase, which converts folic acid to folinic acid, and may help release free folic acid from its conjugates in food.

Vitamin C is a powerful antioxidant, protecting against oxidative damage to DNA, membrane lipids and proteins. As mentioned above, it is involved in the synthesis of numerous substances such as collagen, and also of certain anabolic steroid hormones, and transmitters of the nervous system, lipids and proteins. It seems to be required for proper immune function and its use has been recommended to prevent or treat colds. Although this has not been demonstrated by experimental studies, it seems that Vitamin C does shorten or reduce the severity of a cold. Vitamin C is also a water-soluble cellular antioxidant that reacts with free radicals in the water compartment of cells and in intercellular fluids and can “recycle” vitamin E by chemically regenerating it after it has been spent in terminating a free radical reaction.

Vitamin C (L-ascorbic acid) is a moderately strong reducing agent, which makes it unstable in aqueous solutions, especially at high pHs. It is particularly subject to oxidative degradation.

L-ascorbic acid is chemically defined as an alpha-ketolactone with the following chemical structure: The number 2 and 3 carbons are double-bonded and contain acid-ionizable hydrogen in water (pK=4.2). Ascorbic acid is moderately strong reducing agent. Unfortunately, these properties lead to instability in the ascorbic acid structure which is burdensome to formulators attempting to prepare ascorbic acid solutions such as aqueous solutions. In particular, at higher pH's, the ascorbic acid increasingly becomes the unstable ascorbate anion (the conjugate base of ascorbic acid), which is susceptible to degradation.

L-ascorbic acid limit of solubility in water appears to be about 330 mg/ml in water. L-ascorbic acid is therefore relatively soluble in water. It is much less soluble in glycols such as propylene glycol (50 mg/ml) and in alcohols such as ethanol (10 mg/ml in absolute ethanol) and insoluble in glycerin as stated in the prior art. Although water is the best solvent to provide an ascorbic acid solution, it is one of the worst to protect ascorbic acid against oxidative damages. A proportion of water needs to be replaced with another solvent that provides more stability. The dilemma with ascorbic acid formulations has always been to find a balance between solubilization and stability.

The instability of L-ascorbic acid may be caused by a number of factors including stereo chemical strain. For example, when the 2-hydroxy group ionizes, it places two negative charges in close proximity which favors ring disruption. Furthermore, oxidative degeneration likely promotes instability due to the ascorbate anion's propensity to act as a reductant, thus the molecule is prone to breaking down to form species such as L-threonic acid and oxalic acid. Such breakdowns can be catalyzed by the presence of a transition metal. Degradation may also occur due to tap water mixing.

Various attempts have been made to produce stable solutions of L-ascorbic acid and its salts, but have been met with poor success. Most approaches to formulate and use ascorbic acid were related to dermatology to produce topical treatments for skin not for direct ingestion.

U.S. Pat. No. 2,187,467 discloses aqueous solutions of ascorbic acid stabilized by the addition of salts of alkaline earth metals, ammonium, and soluble salt of a sulfite acid. However, this patent states that the stabilization was not achieved with the acid itself.

U.S. Pat. No. 5,140,043 discloses an ascorbic acid formulation that has a pH below 3.5, preferably below 2.5. A low pH insures that a high proportion of ascorbic acid remains in the protonated, uncharged form. The protonated form is more stable and more easily permeant through skin and mucosae membranes than the non-protonated counterpart. Metals also negatively influence the preponderance of the protonated form of ascorbic acid in a solution. A chelator may therefore be added in ascorbic acid solutions to stabilize the vitamin. The carrier in which the ascorbic acid is dissolved comprises an alkylene glycol, namely propylene glycol. The carrier further comprises hydroxyalkylcellulose, the polyhydroxyl function of which apparently participates in the typical reactions of alcohols. The proportion of water remains very high (more than 50% by weight), which may lead to a relatively rapid degradation at room temperature.

U.S. Pat. No. 4,983,382 discloses the use of polyhydric liquids to solubilize and stabilize ascorbic acid. A mixture of ethanol 55-65% and propylene glycol 20-25% is especially preferred for its excellent cosmetic properties. Water may be present in concentrations up to 12% without adversely affecting the stability of ascorbic acid solubilized in a mixture of alcohol and propylene glycol. The organic solvents, all combined, represent up to 90% by weight of a composition. The low water contents recommended does not appear to permit solubilization of more than 10% of ascorbic acid.

U.S. Pat. No. 6,124,348 proposes to combine ascorbic acid, a volatile organic solvent such as isodecane and a gelling base. The solvent does not react with or solubilize the vitamin. Such a suspension is applied to the skin. The skin moisture penetrates the suspension and solubilizes the ascorbic acid which then can permeate the skin layer. The solubility of ascorbic acid in the formulation is not dealt with in this patent.

Another type of dispersion of ascorbic acid is disclosed in U.S. Pat. No. 6,103,267. Again, this patent does not describe a solution of ascorbic acid.

Another approach to stabilize ascorbic acid solution has been to decrease water activity in the same. U.S. Pat. No. 5,736,567 discloses compositions wherein water activity is decreased below 0.85. The lowest water activity achieved with the descriptive examples has been 0.63. At this value, the water content is 21%, the ascorbic acid concentration is 3%, the polypropylene glycol content is 39.4% and polyethylene glycol content is 13% (all percentages given by weight of formulation). The aqueous phase is combined with an oil phase to provide a composition that has a “structure”. This particular formulation has been tested for its stability. After two months at 20 degree C., 0.7% of ascorbic acid has degraded which is fairly good compared to the same solution prepared with 28% water (3.5% degradation) and a composition also comprising 28% water but without the glycols (6.2% degradation). The concentration of ascorbic acid that may be present in these formulations is not higher than 10%.

U.S. Pat. No. 6,087,393 discloses a composition comprising ascorbic acid in a mixed glycerol carrier. The glycerol carrier comprises propylene glycol and butylene glycol, as well as a stabilizer which may be diethylene glycol monoethylether. The preferred proportions of propylene glycol, butylene glycol and diethylene glycol monoethylether are 25-80%, 5-30% and 5-10%, respectively. Ascorbic acid may be present in concentrations comprised between 2% and 15%. In these solutions, the major glycol component is clearly propylene glycol while butylene glycol is added as a solubilizing aid and diethylene glycol monoethylether is added in minor proportion as a stabilizer. The stability of these solutions is not excellent because, at best, the samples admittedly start to develop a yellowish color after one month at room temperature.

Another approach to formulate and use ascorbic acid in dermatology has been not to deal with its stability. U.S. Pat. No. 5,953,584 proposes to provide separate compartments that are extemporaneously mixed together prior to use. One compartment comprises vitamin C, the other one comprises an aqueous phase. Once reconstituted by admixing the contents of both compartments, ascorbic acid is provided in a solution that is more alkaline than usual solutions of ascorbic acid. The limit of solubility of the vitamin achieved with such a solution is close to 50%. Further, once reconstituted, the ascorbic acid formulation comprises about half-and-half polyethylene glycol and water.

Because most attempts to date have been made to produce stable solutions of L-ascorbic acid and its salts were related to dermatology to produce topical treatments for skin, no special attention had been given to organoleptic properties of the resulting preparation for direct consumption or the acceptability or toxicity of solvents utilized.

Propylene Glycol has a negative connotation in the food and beverage industries because of its bitter taste, and frequently used as a solvent for flavor ingredients. Consumers as well limit the amount of propylene glycol consumed because it works as a laxative.

A humectant is a hygroscopic substance. It is often a molecule with several hydrophilic groups, most often hydroxyl groups, but amines and carboxyl groups, sometimes estrified, can be encountered as well; the affinity to form hydrogen bonds with molecules of water is crucial here. Since hygroscopic substances absorb water from the air, they are frequently used in desiccation.

When used as a food additive, the humectant has the effect of keeping the foodstuff moist. Humectants reduce the water activity of liquid. Water activity or a_{w} is a measurement of the energy status of the water in a system. It is defined as the vapor pressure of water divided by that of pure water at the same temperature; therefore, pure distilled water has a water activity of exactly one.

There are several factors that control water activity in a system. Colligative effects of dissolved species (e.g. salt or sugar) interact with water through dipole-dipole, ionic, and hydrogen bonds. Capillary effect where the vapor pressure of water above a curved liquid meniscus is less than that of pure water because of changes in the hydrogen bonding between water molecules. Surface interactions in which water interacts directly with chemical groups on undissolved ingredients (e.g. starches and proteins) through dipole-dipole forces, ionic bonds (H3O+ or OH—), van der Waals forces (hydrophobic bonds), and hydrogen bonds. It is a combination of these three factors in a food product that reduces the energy of the water and thus reduces the relative humidity as compared to pure water. Water activity is temperature dependent. Temperature changes water activity due to changes in water binding, dissociation of water, solubility of solutes in water, or the state of the matrix. Although solubility of solutes can be a controlling factor, control is usually from the state of the matrix.

Oral dosage forms of nutritional supplements remain a significant problem for a significant segment of the population. Many individuals are unable or unwilling to swallow a solid dosage form. This problem occurs primarily in children and the elderly; however, problems with swallowing are not limited to those segments of the population. Certain conditions or disease states manifest themselves by swallowing difficulties. Otherwise healthy individuals can also exhibit problems with swallowing. Such swallowing difficulties irrespective of their cause can severely compromise patient compliance.

The neutraceutical industry has long-recognized the need for a form of oral administration, which avoids the swallowing difficulties associated with a traditional tablet. Syrups, elixirs, microcapsules containing slurries, chewable tablets and other novel tablet or capsule dosage forms have been developed, nevertheless, each has its' own disadvantages. The disadvantages include a costly process for preparation, the limitation of delivering only a small amount of active ingredients and/or more costly packaging materials.

Current offering of oral nutritional supplements in the market place for the treatment of various nutritional needs include: dry pills or capsules (requires long time for dissolving in the stomach, has questionable absorption rate, may require several or large pills) dry powders (require addition to large amount of fluids making them inconvenient to carry or consume, taste is questionable), elixirs and syrups (bulky, hard to carry, unpleasant taste has been a deterrent to broad acceptance by consumers), chewable tablets and other chews (taste is questionable, smaller dosage than needed may be delivered).

Chewable systems have been developed to deliver vitamins and other nutrients; however, they are based on low water content and low water activity for preservations. Such formulations are too firm to chew, excessively sticky to the teeth and require long time of chewing. Edible nutritional supplements that are chewable have to posses acceptable taste otherwise consumption and compliance by consumers will be affected.

An ideal liquid vitamin concentrate will have to deliver sufficient active ingredients, exhibit long stability as well as provide a convenient and desirable way in utilization. For instance, tablet supplements containing 1000 mg vitamin C are large in size and hard to swallow. Such a high dosage represents a challenge to consumers who will have to swallow numerous large pills. A novel delivery system is needed to deliver elevated concentrations of active ingredients in an easy to swallow fashion with acceptable taste and flavor. That system will offer convenience and improve compliance of utilization. There is a need to provide a preparation that is stable over long storage under adverse conditions. Accordingly, there is a need for an improved nutritional supplement that can promote a healthy lifestyle and avoid drawbacks of prior art.

### SUMMARY

The present invention relates to composition and method for producing individual dosages of stabilized ascorbic acid and other vitamins for mammals.

The method of the present invention includes the making of a composition for dispensing high dose of vitamins and herbs in concentrated forms that may be reconstituted in water and ingested.

The present invention relates to composition and method for producing individual dosages of stabilized ascorbic acid and other vitamins characterized by high concentration for mammals.

The method of the present invention includes a process for making a fluid composition for dispensing high dose of nutritional ingredients in an edible format that is portable and consumable at any place.

The method of the present invention also includes methods for making a composition for dispensing high dose of vitamin C and other vitamins that exhibit unusual stability over prolonged period of time under adverse conditions.

A further embodiment includes a kit comprising a pre-formed hermetically sealed package. The kit includes a stable vitamin C and humectants including glycerin.

Other objects, features and advantages of the present invention will be apparent from these summary and description of preferred embodiments, and will be readily apparent to those skilled in the art having knowledge of gelled products/compositions and their methods of preparation. Such objects, features, benefits and advantages will be apparent from the above as taken in conjunction with the accompanying examples, tables, data and all reasonable inferences to be drawn there from.

### DETAILED DESCRIPTION

The present invention relates to single-phase solution compositions of L-ascorbic acid and glycerin that provide enhanced stability, enhanced solubility as compared to prior compositions. The single-phase solution compositions comprise by weight 5% to 40% L-ascorbic acid and 20 to 95% glycerin.

The present invention includes compositions for manufacturing concentrated stabilized liquid ascorbic acid and other nutritional supplements solutions with long shelf-life.

Further embodiment of the invention is a process for stabilizing ascorbic acid for storage; the process comprising combining a further process for stabilizing L-ascorbic acid for storage comprises combining vitamin C and humectants including glycerin, heating the mixture to about 130 F or above, then adding water and fat soluble vitamins, herbal extracts, useful microorganisms and enzymes.

The present process comprises the step of dissolving ascorbic acid in glycerin at elevated temperature that deemed to be harmful and degrading to ascorbic acid in the prior art.

It was pleasantly surprising to the inventor to discover that vitamins dissolved in glycerin are stable even against elevated temperatures that normally cause their degradation. Furthermore, it was equally surprising to discover that heating ascorbic acid to temperatures above 140 F when present in a glycerin solution does not cause loss of strength or concentration of active vitamin C when performed at the required water activity.

Conventionally, ascorbic acid is the most heat sensitive vitamin of all vitamins. Moreover, liquid vitamin C solutions are extremely unstable especially during extended storage. The inventor has discovered that water activity has an important role in stabilizing vitamins particularly at about 0.6 or under. Glycerin has been demonstrated to provide the best protection at various water activities and temperatures.

To the ordinary skilled of the art it is well known that heating vitamin C solution to elevated temperatures (about 130 F or above) will damage the vitamin and should be avoided. No ordinary skilled in the art will attempt to heat vitamin C solution to high temperature. Ascorbic acid does not dissolve in glycerin at low temperature, however, the inventor has discovered that heating ascorbic acid/glycerin solution would cause minimal damage to ascorbic acid even when heated to about 165 F and above. Without any bearing on the findings or the applications, it is speculated that because ascorbic acid is solubilized in glycerin which provide humectancy, vitamin C is protected and in a state of inactivity. In the presence of very low level of water, the degradation reaction is slowed down significantly. Even though ascorbic acid is solubilized in glycerin, it acts as if it is in a dry state. Dry ascorbic acid and vitamin C powders are known to be more stable than liquid ones where the vitamin is exposed to agents of degradation. Another speculative explanation could be that the affinity of glycerin to form hydrogen bonds with molecules of water will cause a reaction with the 2-hydroxy group preventing ionization and thus preventing placing the two negative charges in close proximity which favors ring stabilization and reduce ring disruption. Furthermore, the proposed mechanism may reduce the oxidative degeneration that usually occurs in the presence of water. It is of particular importance to the inventor to discover that the above mentioned stabilization mechanism is only achieved at elevated temperatures. Glycerin does not support solubility of ascorbic acid at ambient temperature. Heating is necessary to initiate and complete the stabilization reaction.

The inventor has also discovered that other vitamins such as Vitamin A (and its derivatives), Thiamin, Riboflavin, Niacin, Pantothenic Acid, Cyanocobalamine, Folic Acid, Vitamin E, Vitamin D and Vitamin K are protected against loss of activity and potency when various levels of glycerin is present and in particular when the water activity is about 0.60 or below.

Furthermore, the inventor surprisingly discovered that the current composition protects the vitality of natural color, fruit and vegetable juices and flavor present. In addition, it was noticed that various herbal preparations are preserved to a greater extent when added to the current invention's formulation according the method and teaching of the present invention. It appears that nutritional supplements are protected by the presence of humectants low water activities. Since vitamin C is the most sensitive vitamin, it is reasonable to assume that by protecting vitamin C, other vitamins are protected similarly.

Suitable water for use in compositions in accordance with the present disclosure include tap water and/or purified water such as for example de-ionized water or USP water. As a non-limiting example, water may be present in compositions in accordance with the present disclosure in an amount of about 0% to about 50% by weight of the total composition. In embodiments, water may be present in amounts of less than 10%, 20%, 30%, or 40% by weight of the total composition.

Suitable reducing sugars for use in compositions in accordance with the present disclosure include sugars with a ketone or aldehyde group such that the sugar is capable of acting as a reducing agent including mannitol, sorbitol, xylitol, maltitol, lactitol, and/or combinations thereof. In protecting vitamin C, it is believed that the reducing sugar oxidizes first and delays the start of any oxidation of the vitamin C so that excessive oxidation in water is delayed or totally avoided. Optionally, the reducing sugars may be mixed with water to form a reducing sugar solution that can be used to formulate a stable vitamin C composition in accordance with this disclosure.

Propylene glycol is used as humectants and stabilizer (in prepared fruits, vegetables and bakery goods) and as a solvent in flavor solutions and extractions (and in food additives, such as colors, antioxidants, enzymes and emulsifiers). It is also used as plasticizer and softening agent for items such as cork seals. Propylene glycol has been used in heat transfer fluids, beverage chilling and freezing applications, solvents for printing inks used in food packaging and as equipment cleaner, to remove contamination from food processing equipment In countries of the European Union, propylene glycol is not cleared as a general-purpose food grade product or direct food additive. The European Council Directive 95/2/EC on food additives regulate its use in foodstuffs for human consumption. Propylene glycol is cleared for use as a carrier and carrier solvent in colors, emulsifiers, antioxidants and enzymes at a maximum content of 1 gram per kilogram of final foodstuff. Propylene glycol was assigned the E-number E1520.

In embodiments in accordance with the present disclosure, sorbitol, maltitol, sodium lactate, corn syrup is used as humectant agents at 76% of solution (W/W).

Glycerol is a chemical compound with the formula HOCH₂CH(OH)CH₂OH. This colorless, odorless, viscous liquid is widely used in pharmaceutical formulations. Also commonly called glycerin or glycerin, it is a sugar alcohol, and is sweet-tasting and of low toxicity. Glycerol has three hydrophilic alcoholic hydroxy groups that are responsible for its solubility in water and its hygroscopic nature. In foods and beverages, glycerol serves as humectant, solvent and sweetener, and may help preserve foods. It is also used as filler in commercially prepared low-fat foods (i.e., cookies), and as a thickening agent in liquors. Glycerol also serves as a way, along with water, to preserve certain types of leaves. Glycerol is also used as a sugar substitute. In this regard, it has approximately 27 calories per teaspoon and is 60% as sweet as sugar. Although it has about the same food energy as table sugar, it does not raise blood sugar levels, nor does it feed the bacteria that form plaques and cause dental cavities. As a food additive, glycerol is also known as E422. Glycerol is used in medical and pharmaceutical and personal care preparations, mainly as a means of improving smoothness, providing lubrication and humectancy. It is found in cough syrups, elixirs and expectorants, toothpaste, mouthwash, skin care and soaps. It is also used as a substitute for ethanol as a solvent in preparing herbal extractions. It is less extractive and is approximately 30% less able to be absorbed by the body. Glycerin is used at levels ranging from 36 to 86% to impact water activity levels ranging from about 0.07 to 0.83.

Optionally, glycerin may be mixed with water to form a solution that can be used to formulate a stable vitamin C composition in accordance with this disclosure. The glycerin vitamin solution may contain, for example, an amount of about 30% and about 95% by weight of the total solution as glycerin. In other embodiments, reducing sugar solution may contain about 76% by weight of the total reducing sugar solution.

The pH of the aqueous compositions in accordance with the present disclosure may be adjusted to be about 1 to about 6, and, in some particularly useful embodiments below 5. The pH of the composition ensures that most of the ascorbic acid remains in the protonated, uncharged form. The protonated form of ascorbic acid used in compositions of the present disclosure is believed to remove the ionic repulsion of the two oxygen groups, thus helping to stabilize the molecule. Agents suitable for adjusting the pH of the aqueous phase include, but are not limited to citric acid, phosphoric acid, lactic acid or glycolic acid. The pH adjustment agents may be present in an amount of about 0.01% to about 9% by weight of the total composition.

Suitable salt or derivative forms of vitamin C include any salt formed from the neutralization of ascorbic acid. Non-limiting examples include sodium ascorbate formed by the neutralization ascorbic acid with sodium to form L-ascorbic acid-monosodium salt. Other non-limiting examples of useful forms include calcium ascorbate, magnesium ascorbate, potassium ascorbate, manganese ascorbate, zinc ascorbate, molybdenum ascorbate, chromium ascorbate, and combinations thereof.

The vitamin C may be present in amounts that provide a benefit to the health of a user. In embodiments, vitamin C is present in an amount sufficient to promote therapeutic or corrective impact. The vitamin C present may be in acidic form, salt form, or mixtures thereof. As an illustrative example, vitamin C in amounts of about 5% to about 40% by weight of the total composition may be suitable. In embodiments, vitamin C is present in an amount of about 15% to about 25% by weight of the total composition, and in some embodiments in amounts of about 1% to about 22% by weight of the total composition.

The components of the composition are in a form that is systemically ingestible in an animal or human. The components employed in the method may be of various forms, consistencies or physical statuses. The nutraceuticals compounds that could be utilized in the method may be pre-hydrated, pre-solubilized, pre-coated, pre-encapsulated, microencapsulated, micronized, particulate, micro-particulated or prepared as timed-release components either individually or in various combinations. The aqueous solution may further include water, one or more reducing sugars, one or more herbs, one or more vitamins, one or more surfactants, one or more flavors, one or more plant extracts such as phytosterols, and combinations thereof.

The present composition and method can employ numerous types of vitamins, probiotics, enzymes, hormones, nutritional supplements synthetic compounds or other nutritional compounds and mixtures thereof in various forms and shapes.

Examples of nutraceuticals hat may be employed in this method may include but not limited to: vitamins (I.E. A, B, C, D, E, K) minerals (i.e. iron, calcium, copper, zinc, chromium, potassium, phosphorus, magnesium), soluble and non soluble fiber (i.e. pectin, oat bran, Psyllium, cellulose), probiotics (i.e. Acidophilus, Bifid bacterium), enzymes (i.e. proteinase, lipase), thermogenic compounds, energy compounds, sports nutrients and other sports and anabolic compounds, nutritional material (i.e. amino acids, L-glutamine, taurine, whey proteins, animal and plant proteins, peptides), fatty acids (and derivative off), various functional hormones and herbal preparations (i.e. Ginseng, Echinacea, Goldenseal). The components employed in the method may be of various forms, consistencies or physical statuses. The nutraceutical compounds that could be utilized in the method may be pre-hydrated, pre-solubilized, pre-coated, pre-encapsulated, microencapsulated, micronized, particulated, and micro-particulated or prepared as timed-release components either individually or in various combinations.

Optionally, the present liquids can include effective amounts of flavor(s). If present, such flavors can comprise effective amounts of flavors to provide desired flavor levels. Generally, flavors present at from about 0.01% to about 10% of the finished products are contemplated.

Suitable non-nutritive sweeteners may also be used for sugar-free fictional foods. Example of non-nutritive sweeteners includes Sucralose, Aspartame, Saccharin and other high potency sweeteners. Suitable materials for use as nutritive carbohydrate sweetening agents are well known in the art. Examples of sweetening agents include both monosaccharide and disaccharide sugars such as sucrose, invert sugar, dextrose, lactose, honey, maltose, fructose, maple syrup and corn syrup or corn syrup solids. Example nutritive carbohydrate sweetening agents include those selected from the group consisting of sucrose, glucose, fructose, and corn syrup solids. Suitable materials for use in the current invention are those liquids and fluids with minimal amount of water (about 30% or less). Example of other sweeteners is polyols (also referred to as sugar alcohols, part of polyols' chemical structure resembles sugar and part is similar to alcohols, the terms polyhydric alcohols and polyalcohols may also be used). Polyols group includes maltitol, sorbitol, xylitol, mannitol, isomalt and hydrogenated starch hydrolysate. Other examples of suitable sweeteners are lactitol monohydrate, and erythritol, syrups of sweeteners such as maltose, fructose, glucose or natural syrups such as honey, maple syrup and corn syrup.

The present compositions can optionally contain a variety of additional ingredients suitable for rendering such products more organoleptically acceptable, more nutritious and/or more storage stable. Such optional components may include colors, coloring agents, preservatives, emulsifiers, acidity and pH modifiers (acids and alkaline). Of course, mixtures of the above-noted materials are contemplated herein.

Any of processing vessels may be used to combine and heat-treat the ingredients. A laboratory processor was utilized to impact mixing and heating of components.

Any sequence of ingredients addition may be adopted before the incorporation of nutraceuticals. In one embodiment, water and glycerin are added first to the processor. Next ascorbic acid is added with continuous agitation. Heating is commenced to about 130° F.-190° F. Upon the complete solubilizatin of vitamin C, the temperature of the system may be reduced to about 80-115° F. before the addition of nutraceuticals in order to minimize the detrimental impact of heat on active ingredients if needed for heat sensitive components (such as hormones, bacteria and enzymes). Fat and water soluble neutraceutical preparations, flavors, sweeteners, acidity modifiers, colors or other optional ingredients are then added.

The resultant pasteurized product has a flowable consistency suitable for further filling into suitable containers. Cooling of the finished product is optional.

The liquid concentrated supplement may be filled using any of the filling equipment known to those skilled in the art of packaging technology. The nutritionally functional product may be dispensed into plastic, glass, foil, synthetic materials, and paper or like containers or packages.

The nutritionally functional product may be additionally dispensed into hermetically sealed packages for extended shelf life. Dispensing the compositions into hermetically sealed unit dose offers portability, rigidity, and formability. It also provides protection against moisture, gas and microbiological contamination extending the shelf life of unit dose.

The stabilized fluid preparations may be handled and distributed either at room temperature, refrigerated or frozen depending on the type of nutraceutical compounds, distribution channels and the end-user.

### EXAMPLES

This invention is further illustrated by the following examples, which are to be regarded as illustrative only, and in no way limit the scope of the invention. The following non-limiting examples and data illustrate various aspects and features relating to the method(s) and resulting products/compositions of this invention, including the surprising and unexpected modification, control and/or improvement of the water activity level through use/incorporation of the humectants of this invention.

### Example 1

The solubility of ascorbic acid in various solvents and humectants was examined. Liquid nutritional supplements were produced according to the teachings of the present invention. The liquid nutritional supplements were formulated using various solvents individually as shown below. All ingredients were mixed together in a laboratory processor to make 1000 grams batches. Glycerin (GL), propylene glycol (PG), sorbitol (SR), maltitol (ML), corn syrup 63/43 (CS) and sodium lactate (SL) were added at percentage (w/w) of ingredients as follows:

TABLE 1
Formulations of various vitamin C solutions.

| | Sample | | | | | |
|---|---|---|---|---|---|---|
| | GL | PG | SR | ML | CS | SL |
| Ingredient | % | % | % | % | % | % |
| Citric Acid | 3.00 | 3.00 | 3.00 | 3.00 | 3.00 | 3.00 |
| Ascorbic Acid | 11.00 | 11.00 | 11.00 | 11.00 | 11.00 | 11.00 |
| Glycerin | 76.00 | | | | | |
| Propylene | | 76.00 | | | | |
| Glycol | | | | | | |
| Sorbitol | | | 76.00 | | | |
| Maltitol | | | | 76.00 | | |
| Corn Syrup | | | | | 86.00 | |
| 63/43 | | | | | | |
| Sodium Lactate | | | | | | 76.00 |
| Water | 10.00 | 10.00 | 10.00 | 10.00 | 0.00 | 10.00 |
| Total | 100.00 | 100.00 | 100.00 | 100.00 | 100.00 | 100.00 |

Heating and stirring commenced until all ascorbic acid has been completely dissolved. Durations as well as temperatures were recorded.

TABLE 2
Time required to completely dissolve vitamin C at various temperatures
of addition and corresponding water activity measured at 23.5 C.

| | Sample | | | | | |
|---|---|---|---|---|---|---|
| | GL | PG | SR | ML | CS | SL |
| Water Activity (at | 0.2960 | 0.9420 | 0.7810 | 0.8200 | 0.5450 | 0.6510 |
| 23.5 C.) | | | | | | |
| Temperature of Addition | 160 | 144 | 132 | 138 | 167 | 135 |
| Time to Dissolve, | 25.0 | 8.5 | 7.0 | 7.0 | 55.0 | 5.5 |
| Minutes | | | | | | |

It was observed that sorbitol, maltitol and sodium lactate required the least temperature as well as the shortest time to completely dissolve ascorbic acid followed by propylene glycol. Corn syrup required the highest temperature as well as the longest time. Glycerin required high temperature (160 F) and 25 minutes to completely dissolve. It should be noticed that sugar alcohols may readily dissolve ascorbic acid at low temperature with constant steering. In the case of glycerin, if temperature is not raised, ascorbic acid will remain undissolved and precipitate at the bottom of the beaker. That renders using glycerin unobvious for the ordinary skilled in the art because heat damages vitamin C severely as documented in the literature. Glycerin, surprisingly produced the lowest water activity (Aw) of 0.296 after dissolving ascorbic acid.

### Example 2

Example 2 illustrates the stability of ascorbic acid of various solvents containing dissolved vitamin C. About 12 grams of the liquid nutritional supplements produced according to example 1, were dispensed into hermetically sealed ampoules. The film used in thermoforming the ampoules was manufactured using PCV/PE resin and contained no dyes to provide a clear film with transparent properties to observe changes in appearance. Three ampoules filled with various solutions containing ascorbic acid were incubated at about 140 F for 11 days. Bubble formation (sign of vitamin C decarboxylation) bloating of ampoules (sign of vitamin C degradation) and color changes (sign of Vitamin C instability) were recorded.

The following descriptive nomenclature was used to identify the degree of bubble formation: N=no bubbles, S=slight bubble formation, H=excessive bubble formation.

The following descriptive nomenclature was used to identify the degree of bloating of ampoule: N=no bloating, LB=light bloating, VB=very bloated, SF=number of seal failure of ampoules.

The following descriptive nomenclature was used to identify the degree of color change of ampoule: T=typical no color change, SY=slight yellow, MD=medium yellow, DP=deep yellow.

TABLE 3
Stability of ascorbic acid at various solvents containing dissolved
vitamin C

| | Sample | | | | | |
|---|---|---|---|---|---|---|
| | GL | PG | SR | ML | CS | SL |
| 6 hrs | | | | | | |
| Color | T | T | T | T | T | T |
| Bubble Formation | N | N | N | N | N | N |
| Bloating | N | N | N | N | N | N |
| 15 hrs | | | | | | |
| Color | T | T | T | SY | SY | SY |
| Bubble Formation | N | N | S | S | S | S |
| Bloating | N | N | N | SB | SB | SB |
| Day 1 | | | | | | |
| Color | T | T | MY | SY | SY | VB |
| Bubble Formation | N | N | H | H | S | H |
| Bloating | N | N | VB | VB | LB | SF 3/3 |
| Day 1 and ½ | | | | | | |
| Color | T | T | MY | SY | SY | |
| Bubble Formation | N | N | H | S | S | |
| Bloating | N | N | VB | VB | LB | |
| Day 2 | | | | | | |
| Color | T | T | DY | SY | DY | |
| Bubble Formation | N | N | H | S | S | |
| Bloating | N | N | VB | VB | VB | |
| Day 3 | | | | | | |
| Color | T | T | DY | DY | DY | |
| Bubble Formation | N | N | H | H | H | |
| Bloating | N | N | SF 3/3 | SF 3/3 | VB | |
| Day 4 | | | | | | |
| Color | T | T | | | DY | |
| Bubble Formation | N | N | | | H | |
| Bloating | N | N | | | VB | |
| Day 5 | | | | | | |
| Color | T | T | | | DY | |
| Bubble Formation | N | N | | | H | |
| Bloating | N | N | | | SF 3/3 | |
| Day 6 | | | | | | |
| Color | SY | SY | | | | |
| Bubble Formation | N | S | | | | |
| Bloating | N | LB | | | | |
| Day 7 | | | | | | |
| Color | SY | SY | | | | |
| Bubble Formation | N | S | | | | |
| Bloating | SB | LB | | | | |
| Day 11 | | | | | | |
| Color | SY | DY | | | | |
| Bubble Formation | S | H | | | | |
| Bloating | SB | VB | | | | |

Only glycerin and propylene glycol showed stability during the 11 days incubation at high temperature with glycerin outperforming propylene glycol after 5 days. It was surprising to discover that propylene glycol may stabilize vitamin C longer than other humectants even though it did not lower the water activity to a great extent. It is the inventor's experience that one day at 140 F may correspond to one month of shelf stability at ambient temperature. Based on the unexpected results, it appears that glycerin is the optimal humectant to stabilize vitamins in general and vitamin C in particular. Ampoules and other small packages show signs of bloating and expand until bursting occur (seal failure). Gas production is another observation of evident degradation of vitamin C. In destabilized single doses, gas bubbles may be seen rising to the top of the package leading to deformation of the package and eventually bursting of package. The explosion and package seal failure will impact a costly economic loss when nutritional supplements are shipped and stored especially at hot climates. Increased stability of nutritional supplements as taught in the current invention is of great economic value. Additionally, glycerin is the solvent of choice because of less desirable characteristics associated with propylene glycol. A mixture of glycerin and other humectants and propylene glycol may be also of advantage to stabilize vitamin C.

### Example 3

To further evaluate the impact of various levels of glycerin on water activity and dissolution parameters of vitamin C, the following perpetrations were developed:

TABLE 4
Vitamin C formulations at various glycerin concentrations.

| | Sample | | | | | | |
|---|---|---|---|---|---|---|---|
| | Control | A | B | C | D | E | F |
| Ingredient | % | % | % | % | % | % | % |
| Citric Acid | 3.0 | 3.0 | 3.0 | 3.0 | 3.0 | 3.0 | 3.0 |
| Ascorbic Acid | 11.0 | 11.0 | 11.0 | 11.0 | 11.0 | 11.0 | 11.0 |
| Glycerin | 0 | 36 | 46 | 56 | 66 | 76 | 86 |
| Water | 86.0 | 50.0 | 40.0 | 30.0 | 20.0 | 10.0 | 0.0 |
| Total | 100.0 | 100.0 | 100.0 | 100.0 | 100.0 | 100.0 | 100.0 |

Table 5 below illustrates temperature and time required to solubilize vitamin C in glycerin as well as resulting water activity and specific gravity:

TABLE 5
Illustration of temperature and time required to solubilize vitamin C in glycerin

| | Sample | | | | | | |
|---|---|---|---|---|---|---|---|
| | Control | A | B | C | D | E | F |
| Temperature of Addition | 85 F. | 115 F. | 135 F. | 150 F. | 155 F. | 160 F. | 165 F. |
| Time to Dissolve, Minutes | 2 | 4 | 6 | 7 | 18 | 25 | 40 |
| pH | 1.80 | 1.72 | 1.72 | 1.64 | 1.48 | 1.03 | 0.60 |
| Water Activity (at 23.5 C.) | 0.99 | 0.83 | 0.78 | 0.65 | 0.51 | 0.30 | 0.07 |
| Specific Gravity | 1.07 | 1.10 | 1.16 | 1.20 | 1.22 | 1.24 | 1.28 |
| Volume, ml | 10.00 | 10.00 | 10.00 | 10.00 | 10.00 | 10.00 | 10.00 |
| Weight, g | 10.70 | 11.00 | 11.60 | 12.00 | 12.20 | 12.40 | 12.80 |

and resulting water activity and specific gravity.

Water activity decreased as the amount of glycerin increased. The higher the amount of glycerin, the higher the temperature of incorporation required and the longer the time required. In order to achieve a low level of water activity of about 0.80 or below, it was concluded high levels of glycerin (about 46%) and temperature of above the detrimental temperature (135 F) are required. To achieve complete solubilization at that temperature, about 6 minutes of heat exposure is needed which in a conventional solution may severely damage vitamin C. To obtain lower water activity, a more detrimental treatment is needed which may as documented in the literature irreversibly degrade vitamin C.

### Example 4

Table 6, demonstrates the recovery of added vitamin C at various water activities, temperature and minutes. Glycerin solutions prepared as in example 3 were analyzed for vitamin C recovery.

TABLE 6
Recovery of added vitamin C at various water activities, temperature and minutes

| | Sample | | | | | | |
|---|---|---|---|---|---|---|---|
| | Control | A | B | C | D | E | F |
| Ascorbic Acid Added | 11.00% | 11.00% | 11.00% | 11.00% | 11.00% | 11.00% | 11.00% |
| Ascorbic Acid Measured | 12.21% | 12.50% | 11.47% | 11.96% | 11.20% | 11.83% | 11.71% |
| % Recovery | 111.00 | 113.64 | 104.27 | 108.73 | 101.82 | 107.55 | 106.45 |

All preparations exhibited remarkable recovery of vitamin C. By incrementally lowering the water activity, no or little loss of vitamin C occurred even as the temperature was raised to 165 F for an unusual duration of 40 minutes. It was pleasantly surprising to discover that vitamin C vitality could be preserved at high temperature for long time. It is believed that this is the first time a heat sensitive nutrient could be protected during processing.

### Example 5

Example 5 illustrates the stability of ascorbic acid in various concentrations of glycerin. About 12 grams of the liquid nutritional supplements produced according to example 3, were dispensed into hermetically sealed ampoules. The film used in thermoforming the ampoules was manufactured using PCV/PE resin and contained no dyes to provide a clear film with transparent properties to observe changes in appearance. Three ampoules filled with various solutions containing ascorbic acid were incubated at about 140 F for 30 days. Bubble formation (sign of vitamin C decarboxylation) bloating of ampoules (sign of vitamin C degradation) and color changes (sign of Vitamin C instability) were recorded.

The following descriptive nomenclature was used to identify the degree of bubble formation: N=no bubbles, S=slight bubble formation, H=excessive bubble formation.

The following descriptive nomenclature was used to identify the degree of bloating of ampoule: N=no bloating, LB=light bloating, VB=very bloated, SF=number of seal failure of ampoules.

The following descriptive nomenclature was used to identify the degree of color change of ampoule: T=typical no color change, SY=slight yellow, MD=medium yellow, DP=deep yellow. Table 7 summarizes the findings:

TABLE 7
Stability of ascorbic acid in various concentrations of glycerin

| | Sample | | | | | | |
|---|---|---|---|---|---|---|---|
| | Control | A | B | C | D | E | F |
| 0 hrs | | | | | | | |
| Color | T | T | T | T | T | T | T |
| Bubble Formation | N | N | N | N | N | N | N |
| Bloating | N | N | N | N | N | N | N |
| 8 hrs | | | | | | | |
| Color | SY | T | T | T | T | T | T |
| Bubble Formation | N | N | N | N | N | N | N |
| Bloating | N | N | N | N | N | N | N |
| 16 hrs | | | | | | | |
| Color | My | SY | SY | T | T | T | T |
| Bubble Formation | S | S | S | N | N | N | N |
| Bloating | SLB | SLB | SL | N | N | N | N |
| Day 1 | | | | | | | |
| Color | DY | SY | SY | SY | T | T | T |
| Bubble Formation | H | S | S | S | N | N | N |
| Bloating | SF 1/3 | VB | SLB | SLB | N | N | N |
| Day 1.5 | | | | | | | |
| Color | DY | SY | SY | SY | T | T | T |
| Bubble Formation | H | H | H | SY | N | N | N |
| Bloating | SF 3/3 | SF3/3 | VB | LB | N | N | N |
| Day 2 | | | | | | | |
| Color | | | MY | MY | SY | T | T |
| Bubble Formation | | | H | H | S | N | N |
| Bloating | | | VB | VB | SB | N | N |
| Day 3 | | | | | | | |
| Color | | | DY | DY | SY | T | T |
| Bubble Formation | | | H | H | S | N | N |
| Bloating | | | SF | VB | SB | N | N |
| | | | 2/3 | | | | |
| Day 4 | | | | | | | |
| Color | | | DY | DY | SY | T | T |
| Bubble Formation | | | H | H | S | N | N |
| Bloating | | | SF | VB | SB | N | N |
| | | | 3/3 | | | | |
| 90 hr | | | | | | | |
| Color | | | | DY | SY | SY | T |
| Bubble Formation | | | | H | H | N | N |
| Bloating | | | | SF 3/3 | VB | SB | N |
| Day 5 | | | | | | | |
| Color | | | | | SY | SY | T |
| Bubble Formation | | | | | H | N | N |
| Bloating | | | | | VB | SB | N |
| Day 6 | | | | | | | |
| Color | | | | | DY | SY | T |
| Bubble Formation | | | | | H | S | N |
| Bloating | | | | | VB | SB | N |
| Day 7 | | | | | | | |
| Color | | | | | DY | SY | T |
| Bubble Formation | | | | | H | S | N |
| Bloating | | | | | VB | SB | N |
| Day 8 | | | | | | | |
| Color | | | | | DY | SY | T |
| Bubble Formation | | | | | H | S | N |
| Bloating | | | | | SF 1/3 | SB | N |
| Day 16 | | | | | | | |
| Color | | | | | DY | DY | T |
| Bubble Formation | | | | | H | H | N |
| Bloating | | | | | SF 1/3 | VB | N |
| Day 30 | | | | | | | |
| Color | | | | | DY | DY | T |
| Bubble Formation | | | | | H | H | N |
| Bloating | | | | | SF 1/3 | VB | N |

It could be concluded from the data above that the higher the glycerin level (lower Aw) in the nutritional supplement, the more stable vitamin C. Even glycerin levels of 45% may provide otherwise unattainable shelf life equivalent to up to 5 month of active ascorbic acid. Even Aw of 0.50 provided a long shelf life showing no further deterioration after 7 days (may be equivalent to 7 months on the retail shelves. Glycerin concentration of 86% (w/w) and water activity of about 0.07 provided the longest virtually unchanged appearance of vitamin C without apparent color change or gas production. This surprising finding represents an important stabilization technique to produce Vitamin C in hermetically sealed packages. No bloating, gas production in a single serve sealed package will occur, thus enabling to deliver concentrated forms of vitamin C.

### Example 6

Vitamin C was added to the glycerin formulation of example 3 at 5% and 25% with the balance is compensated as water. Similar stability results in sealed ampoules were obtained demonstrating that a wide range of ascorbic acid concentrations may be utilized in the teaching of the current invention without significant loss of activity.

### Example 7

Utilizing a preparation of glycerin level of 60% and ascorbic acid of 9%, various vitamins were added and analyzed for stability. Fat soluble vitamins A and E were added at 2,500 IU and 30 IU respectively. In a second group, water soluble vitamins Thiamine, Riboflavin, Niacin, Pyridoxine, and Caynocolamine were added at 50% of daily values and subjected to the heat treatment of about 160 F for 20 minutes. Water activity was measured at 0.55 and pH at 2.0. Full recovery of added vitamins was obtained emphasizing that if vitamin C is stabilized; inherently other heat or water sensitive nutrients will be stabilized as well.

### Example 8

Utilizing a preparation of glycerin level of 40% and ascorbic acid of 5%, various natural colors, juice concentrates and herbal extracts were added and analyzed for stability. Echinacea and ginseng extracts, pomegranate and carrot juice concentrates were added. Water activity was measured at 0.80 and pH at 3.0. Upon incubation at 140 F for five days, no color change of added juices had been noticed emphasizing that if vitamin C is stabilized, inherently other heat or water sensitive nutrients will be stabilized as well. Herbal extracts appeared to be not affected by heat or incubation time.

### Example 9

To a preparation of 70% glycerin and 20% ascorbic acid and 10% water, about 0.3% of a blend of lipase and protease enzymes were added. Water activity was measured at 0.13 and pH at 1.2. Incubation was performed at 140 F for ten days. By adding the preparation to a base of dairy ingredients and incubating the dairy base for 24 hrs, flavors and tastes produced in the base were similar to the same dosage of enzyme blend (0.3%) added directly to the base. It was concluded that the process of the current invention may protect various enzymes against deterioration.

### Example 10

To the preparation of example 9, a blend of probiotics consisting of L. acidophilus and L. burglarious was added to provide about one hundred billion colonies per gram. Vitality was subjected to about 10 to 50% loss during 7 days of incubation. It was concluded that the process of the current invention may protect various microorganisms against death upon extended storage conditions.

### Example 11

The stability of ascorbic acid in a combination of various humectants was examined. Liquid nutritional supplements were produced according to the teachings of the present invention. The liquid nutritional supplements were formulated using various humectants combination as shown below. All ingredients were mixed together in a laboratory processor to make 1000 grams batches. Glycerin (GL), propylene glycol (PG), sorbitol (SR), maltitol (ML), and corn syrup 63/43 (CS) were combined at percentage (w/w) of ingredients as follows:

TABLE 8
Formulations of various humectants combinations

Sample

| | GSC | GP | GPGM | GPC |
|---|---|---|---|---|
| Ingredient | % | % | % | % |
| Citric Acid | 1 | 1 | 1 | 1 |
| Ascorbic Acid | 10 | 10 | 10 | 10 |
| Glycerin | 46 | 46 | 46 | 46 |
| Propylene Glycol | 43 | | | |
| Sorbitol | | 43 | | |
| Maltitol | | | 43 | |
| Corn Syrup 63/43 | | | | 43 |
| Total | 100 | 100 | 100 | 100 |

TABLE 9
Water activity of various humectants combinations

| | Sample | | | |
|---|---|---|---|---|
| | GSC | GP | GPGM | GPC |
| Temperature of Addition | 165 | 165 | 165 | 165 |
| Time to Dissolve, | 11 | 10 | 16 | 22 |
| Minutes | | | | |
| pH | 1.32 | 1.59 | 1.22 | 1.28 |
| Water Activity (at | 0.752 | 0.386 | 0.317 | 0.242 |
| 23.5 C.) | | | | |

Vitamin C dissolved satisfactorily in various combinations at about 165 F. Water activity ranged between 0.242 and 0.752. Combinations with glycerin showed extended the shelf life more than the humectant alone. Therefore, it could be concluded that glycerin is essential in lowering the water activity when combined with other humectants or propylene glycol.

While the principals of this invention have been described in connection with specific embodiments, it should be understood clearly that these descriptions, along with the chosen tables and data therein, are made only by way of example and are not intended to limit the scope of this invention, in any manner. Other advantages and features of this invention will become apparent from the following claims, with the scope thereof determined by the reasonable equivalents, as understood by those skilled in the art.

What is claimed is:

1. A composition of a stabilized ascorbic acid solution comprising:
a) ascorbic acid and/or one of its derivatives; and
b) glycerin

2. The composition of claim 1, wherein the ascorbic acid and glycerin are heated to about 130 F or above to dissolve ascorbic acid.

3. The composition of claim 1, wherein the ascorbic acid concentration is about 25% (w/w) or less in solution,

4. The composition of claim 1, wherein the glycerin concentration is about 10 to 95% (w/w) in solution.

5. The composition of claim 1, wherein the solution includes added water, nutritional supplements and optional ingredients.

6. The composition of claim 1, wherein the water activity of the solution is about 0.6 or below.

7. The composition of claim 1, wherein the glycerin functions as a solubilizing and preserving agent for ascorbic acid.

8. The composition of claim 1, wherein the pH is below 5.0.

9. The composition of claim 5, wherein the added water is about 20 to 50 (w/w).

10. The composition of claim 5, wherein the added nutritional supplements are selected from the group consisting of water and fat soluble vitamins, antioxidants, juice concentrates, minerals, herbal extracts, liquid extracts of herbs, fiber, prebiotics, probiotics, joint care nutrients, hormones, enzymes, collagen, amino acids, brain stimulating nutrients and combinations thereof.

11. The composition of claim 5, wherein the added optional ingredients is selected from the group consisting of sweeteners, flavors and colors or combinations thereof.

12. A process for obtaining a stabilized ascorbic acid solution of a desired stability, which comprises:
a) mixing ascorbic acid and/or one of its derivatives and a humectant;
b) adding sufficient humectant to lower water activity of solution to about 0.60 or below;
c) heating to about 120 F or above to dissolve ascorbic acid

13. The process of claim 12, wherein the humectant is selected from a group consisting of glycerin, reducing sugars, polyols, maltitol, sorbitol, xylitol, mannitol, isomalt, lactitol, and erythritol or mixtures or derivatives thereof.

14. The process of claim 12, wherein the process further comprises adding between about 5% to 45% water.

15. A kit comprising a preformed package, the kit comprising:
dissolved ascorbic acid and/or one of its derivatives and humectant.

16. The kit of claim 15, wherein the preformed package is hermetically sealed.

17. The kit of claim 15, wherein the composition is a single serve concentrated nutritional supplement to be diluted in water.

18. The kit of claim 15, wherein the glycerin is present at 30 to 95%.

19. The kit of claim 15, wherein the water activity is about 0.60 below.

20. The kit of claim 15, wherein the humectant is selected from a group consisting of glycerin, reducing sugars, polyols, maltitol, sorbitol, xylitol, mannitol, isomalt, lactitol, and erythritol or mixtures or derivatives thereof.
